(19) United States
(12) Patent Application Publication
(10) Pub. No.: US 2010/0149500 A1
(43) Pub. Date: Jun. 17, 2010

(54) PROJECTION LENS FOR MICROLITHOGRAPHY AND CORRESPONDING TERMINAL ELEMENT

(75) Inventor: Eric Eva, Aalen (DE)

Correspondence Address: SUGHRUE MION, PLLC, 2100 PENNSYLVANIA AVENUE, N.W., SUITE 800, WASHINGTON, DC, 20037, US

(73) Assignee: Carl Zeiss SMT AG, Oberkochen (DE)

(21) Appl. No.: 11/993,422

(22) PCT Filed: Jun. 21, 2005
(86) PCT No.: PCT/EP05/06654

§ 371 Date: Oct. 28, 2009

(51) Int. Cl. G03B 27/52; G02B 3/00

(52) U.S. Cl. 355/30; 359/649

(57) ABSTRACT

The invention relates to a projection lens (5) for microlithography, in particular, for immersion lithography, designed to operate at a wavelength of more than 190 nm and comprising an optical element made from quartz glass with an OH content of less than 50 ppm, in particular between 10 ppm and 50 ppm, and a water content of between 1.5×10¹⁶ and 2×10¹⁸ molecules/cm³, preferably between 2×10¹⁶ and 1×10¹⁸ molecules/cm³, in particular between 5×10¹⁶ and 2×10¹⁷ molecules/cm³. The optical element is preferably a terminal element (14) for the projection lens (5) in a microlithography projection illumination unit (1) for immersion lithography.

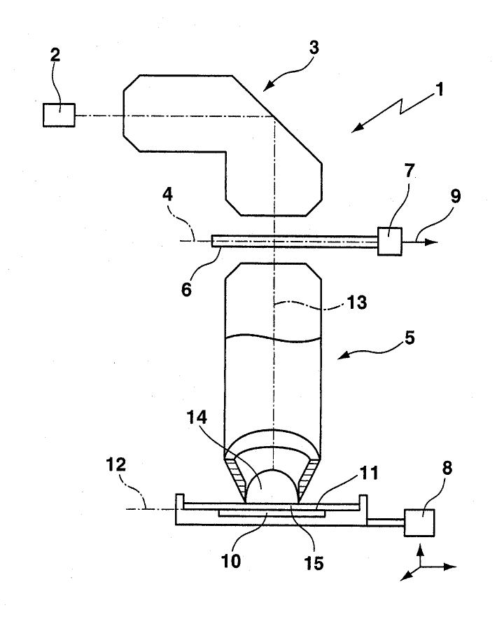

### BACKGROUND TO THE INVENTION

The invention relates to a projection lens for microlithography, in particular for immersion lithography, designed for an operating wavelength of more than 190 nm, comprising at least one optical element made of silica glass, as well as an end element, in particular for such a projection lens, and a microlithography projection exposure apparatus comprising such a projection lens.

Projection lenses for microlithography have been used for several decades in the production of semiconductor elements and other finely structured components. They are used for projecting patterns of photo masks (hereinafter also referred to as “masks” or “reticles”) onto a light-sensitive substrate, for example a semiconductor wafer coated with a light-sensitive coating at the highest resolution at reduced scale.

Preferably silica glass is used as a material for optical elements in such projection lenses with an operating wavelength of, for example, 248 nm or 193 nm. In the case of shorter wavelengths of, for example, 157 nm, there is a problem in that the silica glass is no longer sufficiently transparent for the radiation applied. Various approaches to enhance transmission at this wavelength are known.

DE 199 42 443 A1 (corresponding to U.S. Pat. No. 6,376,401) describes a production process for synthetic silica glass with high transparency to ultraviolet radiation up to wavelengths of 157 nm. A special process, known as the soot process, is to make it possible to reduce the content of hydroxyl groups (OH groups) to the region below approximately 70 ppm while at the same time minimising the content of chlorine and metallic impurities. In this arrangement, minimisation of the content of OH groups is desired with a view to improved transmission, because it is assumed that these hydroxyl groups cause absorption in a band of the ultraviolet range around 165 nm, which absorption results in a reduction of transmission of the silica glass during radiation at a wavelength of 157 nm.

From U.S. Pat. No. 6,782,716 it is furthermore known to use fluorine-doped silica glass, in particular comprising a fluorine content of less than 0.5 weight %, in projection exposure apparatuses for a wavelength range of less than 190 nm. The silica glass described therein is said to provide good transmission to radiation at wavelengths of approximately 157 nm, and is said to therefore be particularly well suited as a substrate for photo masks. In this arrangement the OH content of the silica glass is selected to be as low as possible so as to further improve transmission.

In contrast to the above, from JP 4-97922 it is known that a high content of OH groups is said to lead to a reduction in the induced absorption of the glass during UV laser radiation.

However, adequate transmission of the silica glass material is only one prerequisite for determining the suitability for use in highly complex optical systems, for example illumination systems or projection lenses for microlithography. It is known that laser radiation, for example at a wavelength of 193 nm, can result in radiation-induced changes in the density of the silica glass material, which changes in density are associated with changes in the refractive index. In lithography systems, these changes in the optical characteristics can, among other things, result in imaging errors that limit the service life of the systems and that may necessitate replacement and re-adjustment.

Radiation-induced compression of the silica glass material, which compression is associated with an increase in the refractive index in the irradiated region, is an effect that has been known for some considerable time. This effect is referred to as “compaction”. Compaction is a frequently investigated phenomenon that can be proven particularly clearly in the case of radiation involving relatively large energy densities of, for example, more than 0.5 mJ/cm². In order to prevent compaction from occurring to a critical extent at the energy densities and wavelengths experienced in the use of lithography systems, it has been proposed that the silica glass material be pre-radiated at high energy densities or that it be mechanically compressed so that compaction is already largely completed before commissioning the silica glass material, in order to in this way obtain a material that is relatively stable at the in-service radiation densities experienced (compare e.g. U.S. Pat. No. 6,205,818 B1 and U.S. Pat. No. 6,295,841 B1).

In particular in the case of lower energy densities in the range of the service energy densities of lithography systems, a contra effect also becomes active, which is associated with a radiation-induced expansion of the material and which causes a reduction in the refractive index. This effect of a radiation-induced reduction in density is referred to as rarefaction. References to this effect are contained in the articles “Radiation effects in hydrogen-impregnated vitreous silica” by J. E. Shelby in J. Appl. Phys., vol. 50, pages 370ff (1979) or “Behavior of Fused Silica Irradiated by Low Level 193 nm Excimer Laser for Tens of Billions of Pulses” by C. K. Van Peski, Z. Bor, T. Embree and R. Morton, Proc. SPIE, vol. 4347, pages 177 to 186 (2001).

### OBJECT OF THE INVENTION

It is the object of the invention to provide a projection lens of the type mentioned in the introduction, in which the at least one optical element made of silica glass has good laser resistance and low inhomogeneity in the refractive index.

### SUMMARY OF THE INVENTION

This object is met by a projection lens of the type mentioned above, comprising at least one optical element of silica glass with an OH content of less than 50 ppm, in particular of between 10 ppm and 50 ppm (weight), and a hydrogen content of between 1.5×10¹⁶ and 2×10¹⁸ molecules/cm³, preferably of between 2×10¹⁶ and 1×10¹⁸ molecules/cm³, in particular of between 5×10¹⁶ and 2×10¹⁷ molecules/cm³.

In contrast to optical elements in projection lenses for 157 nm, in which a lower OH content is desirable so as to improve transmission of the silica glass, at wavelengths above 190 nm the transmission of ordinary silica glass is largely independent of the OH content and is essentially determined by metallic impurities.

However, as a result of the low OH content, in the projection lens according to the invention the inhomogeneities in the refractive index and in the density, which inhomogeneities are caused by compaction and rarefaction, are strongly reduced. Moreover, the low OH content results in a reduction in polarisation-induced birefringence (PIB). A hydrogen content as stated above results in a reduction in induced absorption in the silica glass.

An optical element with a low OH content is preferably produced in a soot process, wherein the soot has to be dried prior to sintering, e.g. by means of a stream of dry air/nitrogen at high temperature, or by vacuum drying. Although as low an OH content as possible is desirable, with these or other known physical methods it is not possible to achieve an OH content of less than 10 ppm.

In an advantageous embodiment the silica glass comprises an OH content of 0.1 ppm to 30 ppm, preferably to 20 ppm, particularly preferably to 10 ppm, extraordinarily preferably to 5 ppm, in particular to 2 ppm, as well as a fluorine content of less than 2000 ppm (weight), preferably of less than 200 ppm, in particular of less than 50 ppm.

In order to further reduce the OH content, instead of air drying, chemical drying with a gas such as HCl or HF is necessary. In both cases the halogen ions are incorporated in the silica glass.

The incorporation of Cl is associated with a disadvantage in that, under radiation, HCl is again released in the glass where it can cause damage (e.g. a decline in transmission). This does not happen with the use of HF, because the bond Si—F is very stable so that no release takes place.

Thus in the soot process the drying effect of fluorine is linked to doping, i.e. the better the drying effect, the larger the fluorine content that is incorporated in the silica glass. However, by means of a suitable selection of partial HF pressure, temperature, drying time etc. in the soot process, the drying effect and the degree of doping can, within limits, be controlled independently of each other. In order to achieve an OH content of below 30 ppm, it can be advantageous to carry out fluorine drying; for an OH content of below approximately 10 to 20 ppm such fluorine drying is mandatory.

A fluorine content in the silica glass further leads to stabilisation of the glass matrix and thus to an increase in the laser resistance of the glass. This becomes plausible considering that silica glass comprises a network of Si—O—Si building blocks, with the possibility of silica glass comprising strongly strained structures with energetically unfavourable bonding angles. Doping with fluorine promotes the formation of terminated silicon-fluorine bonds in the matrix structure of the silica glass. A terminated and chemically resistant Si—F bond (or Si—OH bond) is thus preferable to a weak Si—O bond.

However, the fluorine content must not be selected so as to be excessive, because fluorine has a strong influence on the refractive index, namely in the order of magnitude of almost 1 ppm refractive index for 1 ppm fluorine at 193 nm. Therefore on the one hand the F-concentration in the blank has to be kept very constant (optical homogeneity requirements), and on the other hand the F-content has to be set time and again to the same value from batch to batch. The lower the absolute F-content, the simpler such a procedure is.

Starting from the assumption that it is possible to reproducibly set the absolute content to 10%, 2000 ppm fluorine per weight (i.e. 0.2%) is the upper limit because this leads to approximately 200 ppm refractive index variation, which can only be corrected by means of individual refractive index measuring on each disc and by means of corresponding calculations relating to centre thicknesses and air gaps of the projection lens. If the concentration within a disc can be set to 1% constant, this would result in a refractive index inhomogeneity of 20 ppm. It is thus more practicable to use a fluorine content of 200 ppm at most. In a soot process a fluorine content of approximately 50 ppm is achieved as a rule if good drying of the silica glass is to be achieved.

In a further preferred embodiment the SiH content of the silica glass is minimised. During diffusion of hydrogen into the silica glass at high temperatures, silane and siloxane compounds form more readily, namely the more so the lower the OH content of the silica glass. Silane (SiH) is reversibly split under laser radiation, wherein the decomposition products absorb strongly and in a broadband manner around 215 nm and have a disadvantageous effect on the transmission of the silica glass. Furthermore, a low silane content is advantageous because it leads to reduced dynamic transmission fluctuations of the system and possibly to reduced compaction and PIB.

In a preferred improvement of this embodiment, the silica glass is cold charged. Cold charging with hydrogen refers to charging at a temperature of between room temperature and 500° C. The lower the temperature, the smaller the quantity of silane that is formed; however, the process duration is prolonged in the case of lower temperatures.

In an advantageous improvement the change dkₛₐₜ/dH in the saturation value kₛₐₜ of the absorption coefficient of the silica glass depending on the energy density H is less than 1×10⁻⁴ cm/mJ. While the SiH content in the silica glass can be directly proven by way of Raman spectroscopy, the quantitative meaningfulness of this measuring method is, however, controversial. Nevertheless, indirect proof can be furnished by way of the change dkₛₐₜ/dH, which change is essentially proportional to the SiH content. This change can be determined in that the silica glass is irradiated at 193 nm with any desired pulse sequence rate from 100 to 4000 Hz and in each case with approximately 1 million pulses at least three different energy densities ranging from 0.5 to 4 mJ/cm². The saturation value (final value) of the absorption kₛₐₜ (in cm⁻¹) at each energy density (fluence) H (in mJ/cm²) is then plotted against the energy density H, and by approximation results in a linear dependence whose gradient dkₛₐₜ/dH is determined. Typical hot-charged materials have a gradient dkₛₐₜ/dH of 2 to 10×10⁻⁴ cm/mJ; cold-charged materials are lower by at least one order of magnitude.

In a preferred embodiment the optical element during operation of the projection lens at the operating wavelength, at least in partial regions, is subjected to a pulse energy density of between 200 and 1000 pJ/cm², in particular at a pulse duration of more than 100 ns. The pulse energy densities mentioned are peak values that occur only in a small number of volume elements or surface elements of the optical element. In these regions compaction occurs more readily so that increases in the refractive index of conventional silica glass are more pronounced in these regions than in the surrounding regions that are exposed to laser radiation at a lesser energy density. Consequently an index inhomogeneity in the optical element arises. By using silica glass with the characteristics described above, compaction can be reduced so that the homogeneity of the refractive index in the entire optical element is ensured.

Projection exposure apparatuses for microlithography are usually operated in a pulsed manner, wherein a pulse train has an average duration of, for example, 25 ns. In modern instruments using increased laser energy, a pulse stretcher is used that increases the effective pulse duration (according to the TIS criterion=total integral square) from 25 ns to >100 ns. With the pulse energy density remaining the same, the pulse power density (pulse power density=pulse energy density/effective pulse duration) is reduced by a factor of >4. Such a reduction in the pulse power density also results in reduced compaction, wherein however, due to the parallel increase in the laser energy and in the numeric aperture, the energy density is still excessive and is to be further reduced with the use of silica glass comprising the characteristics described above.

In a further preferred embodiment the optical element is arranged near the focal plane of the projection lens where it is subjected to very considerable radiation exposure, and where, consequently, compaction occurs in a more pronounced manner.

In a further preferred embodiment the optical element is an end element of the projection lens. Such an optical end element is also subjected to high pulse energy density and is thus particularly susceptible to compaction. In particular if the projection lens is an immersion lens, the problems that usually occur during wetting of silica glass with the immersion liquid (e.g. water), in particular salt formation, can be prevented or at least considerably reduced with the use of silica glass comprising the above characteristics, because this silica glass material interacts less strongly with the water and the UV radiation.

Furthermore, as a result of the low OH content in conjunction with the doping of the glass with fluorine, less strong wettability can be achieved so that the accumulation of salts dissolved in the immersion liquid, or other chemical compound formed by UV radiation, is reduced. This effect is also known from chromatography, where the wettability of glass surfaces, e.g. of optical cells, to liquids can be improved if the surfaces are acid treated with HF, as a result of which treatment SiF bonds form locally at the surface.

In a preferred embodiment the projection lens preserves the degree of polarisation of incident radiation to more than 80%, preferably to more than 92%. The polarisation degree of the radiation entering the projection lens, e.g. linear, tangential or radial polarisation, can be maintained at a high percentage during the passage of the radiation if density inhomogeneities and polarisation-induced birefringence of the optical elements of the projection lens can be kept low.

The invention is also implemented in an end element made of silica glass, in particular for a projection lens as described above, in which end element the silica glass comprises an OH content of less than 50 ppm, in particular of between 10 ppm and 50 ppm. In advantageous embodiments of this end element the silica glass comprises the further characteristics described above. Such an end element is, in particular, suitable for use in immersion lithography.

The invention is further implemented in a microlithography projection exposure apparatus comprising a projection lens with an end element as described above, in which projection exposure apparatus an immersion liquid, in particular water, is arranged between the end element and a light-sensitive substrate. With the use of an end element comprising the characteristics described above, as has already been explained above, the problems that occur during wetting of said end element with the immersion liquid can be reduced.

Further characteristics and advantages of the invention are set out in the following description of an exemplary embodiment of the invention, in the figures of the drawing that show details that are significant in the context of the invention, and in the claims. Individual characteristics can be implemented individually per se or several together in any combination in a variant of the invention.

### DRAWING

An exemplary embodiment is shown in the diagrammatic drawing and is explained in the following description. The sole FIGURE shows
a diagrammatic view of an embodiment of an inventive projection exposure apparatus for immersion lithography comprising an end element made of silica glass.

The FIGURE diagrammatically shows a microlithography projection exposure apparatus 1 in the form of a wafer stepper, which projection exposure apparatus 1 is provided for the production of highly-integrated semiconductor components. The projection exposure apparatus 1 comprises an excimer laser 2 with an operating wavelength of 193 nm as a light source, wherein other operating wavelengths, for example 248 nm, are also possible. In its exit plane 4, an illumination system 3 that is arranged downstream creates a large, sharply delimited, very homogeneously illuminated image field that matches the telecentricity requirements of the projection lens 5 that is arranged downstream.

Behind the illumination system a device 7 for holding and manipulating a mask 6 is arranged such that the latter is situated in the object plane 4 of the projection lens 5, and in this plane is movable for scanning operation in a travel direction 9.

Downstream of the plane 4, which is also referred to as the mask plane, there follows the projection lens 5 that images an image of the mask at a reduced scale, for example at a scale of 4:1, 5:1 or 10:1, onto a wafer 10 that comprises a photoresist coating. The wafer 10, which acts as a light-sensitive substrate, is arranged such that the plane substrate surface 11 comprising the photo resist coating essentially coincides with the focal plane 12 of the projection lens 5. The wafer is held by a device 8 that comprises a scanner drive in order to move the wafer synchronously with the mask 6, parallel to said mask 6. The device 8 also comprises manipulators in order to move the wafer both in the z-direction parallel to the optical axis 13 of the projection lens, and in the x- and y-directions perpendicular to this axis.

The projection lens 5 has a hemispherical transparent plano-convex lens that is adjacent to the focal plane 12 as an end element 14, wherein the plane exit face of said plano-convex lens is the last optical surface of the projection lens 5 and is arranged at an operating distance above the substrate surface 11. Between the exit face of the end element 14 and the substrate surface 11 an immersion liquid 15 is arranged, which increases the exit-end numerical aperture of the projection lens 5. In this way, imaging of structures on the mask 6 can take place at greater resolution and focal depth than is possible if the space between the exit area of the end element 14 and the wafer 10 is filled with a medium of a lower refractive index, e.g. air.

During operation of the projection exposure apparatus 1 the material of the end element 14 is irradiated by the laser 2 with intensive laser pulses at an operating wavelength of 193 nm. In this process the end element 14, at least in partial regions, is subjected to a pulse energy density of between 200 and 1000 pJ/cm². At a pulse duration of approximately 100 ns this results in pulse power densities of several kilowatt/cm², which in continuous operation can cause compaction and refractive index inhomogeneities resulting thereof. In order to prevent or at least reduce the above, the end element 14 consists of silica glass with an OH content of less than 50 ppm. During drying of the silica glass with air or nitrogen, i.e. without doping of the silica glass with fluorine, the OH content is preferably between 10 ppm and 50 ppm.

In the case of drying the silica glass with HF as a purge gas and with associated fluorine doping, the OH content is in an interval of 0.1 ppm to 30 ppm, preferably to 20 ppm, particularly preferably to 10 ppm, extraordinarily preferably to 5 ppm, in particular to 2 ppm. The fluorine content of the silica glass is less than 2000 ppm, preferably less than 200 ppm, in particular less than 50 ppm, and is of course different from zero. A fluorine content of approximately 50 ppm has been shown to be particularly advantageous, because not only does it allow good drying, but it is also sufficiently low for the increase in the refractive index inhomogeneity that is associated with fluorine doping not to be too pronounced. Doping with fluorine further ensures improved laser stability of the silica glass.

The silica glass of the end element 14 further comprises a hydrogen content of between 1.5×10¹⁶ and 2×10¹⁸ molecules/cm³, preferably of between 2×10¹⁶ and 1×10¹⁸ molecules/cm³, in particular of between 5×10¹⁶ and 2×10¹⁷ molecules/cm³, as a result of which it is possible to counteract induced absorption. During charging of the silica glass with hydrogen it must be ensured that the silane content of the silica glass is as low as possible, which can be achieved by cold-charging of the silica glass. Such cold-charged silica glass comprises a change dkₛₐₜ/dH of the saturation value of the absorption coefficient kₛₐₜ depending on the energy density H of less than 1×10⁻⁴ cm/mJ.

In particular when the further optical elements (not shown in the FIGURE) of the projection lens 5 are also made from a silica glass material as described above, preservation of the polarisation of the radiation passing through the projection lens 5 is possible to a large extent because refractive index inhomogeneities are reduced.

Furthermore, with the end element 14 comprising “dry” silica glass material, i.e. having a low OH content, which silica glass material is additionally doped with fluorine, it is possible to prevent or at least strongly reduce the problems that usually occur in the wetting of silica glass with water, because such a silica glass material comprises less indiffusion and a lower solubility than conventional silica glass because it comprises a more stable glass matrix. Moreover, by means of the low OH content in conjunction with doping of the glass with fluorine, a less wettable glass surface can be produced so that accumulation of salts dissolved in the immersion liquid 15 on the plane exit face of the end element 14, which exit face is wetted by said immersion liquid 15, can at least be reduced.

1-13. (canceled)

14. A projection lens for microlithography designed for an operating wavelength of more than 190 nm, comprising at least one optical element made of silica glass, wherein the silica glass comprises an OH content of less than 5 ppm, a hydrogen content of between 1.5×10¹⁶ and 2×10¹⁸ molecules/cm³, and a fluorine content of less than 50 ppm.

15. The projection lens according to claim 14, in which the SiH content of the silica glass is minimized.

16. The projection lens according to claim 14, in which the silica glass is cold-charged with hydrogen.

17. The projection lens according to claim 14, in which the change dkₛₐₜ/dH in the saturation value kₛₐₜ of the absorption coefficient of the silica glass depending on the energy density H is less than 1×10⁻⁴ cm/mJ.

18. The projection lens according to claim 14, in which the optical element during operation of the projection lens at the operating wavelength, at least in partial regions, is subjected to a pulse energy density of between 200 μJ/cm² and 1000 μJ/cm².

19. The projection lens according to claim 14, in which the optical element is arranged near the focal plane of the projection lens.

20. The projection lens according to claim 14, in which the optical element is an end element of the projection lens.

21. The projection lens according to claim 14, in which the projection lens preserves the degree of polarization of incident radiation to more than 80%.

22. An end element for a projection lens made of silica glass, in which the silica glass comprises an OH content of less than 5 ppm and a fluorine content of less than 50 ppm.

23. The end element according to claim 22, in which the silica glass comprises a hydrogen content of between 1.5×10¹⁶ and 2×10¹⁸ molecules/cm³.

24. A microlithography projection exposure apparatus comprising a projection lens designed for an operating wavelength of more than 190 nm and an end element according to claim 22, wherein an immersion liquid is arranged between the end element and a light-sensitive substrate.
